(19) United States
(12) Patent Application Publication
(10) Pub. No.: US 2024/0155640 A1
(43) Pub. Date: May 9, 2024

(54) TECHNIQUES FOR MONITORING A PHYSICAL DOWNLINK CONTROL CHANNEL IN A MULTI-CELL SCHEDULING SCENARIO

(71) Applicant: QUALCOMM Incorporated, San Diego, CA (US)

(72) Inventors: Kazuki TAKEDA, Minato-ku (JP); Jae Ho RYU, San Diego, CA (US); Hobin KIM, San Diego, CA (US); Heechoon LEE, San Diego, CA (US)

(21) Appl. No.: 18/464,980

(22) Filed: Sep. 11, 2023

Related U.S. Application Data
(60) Provisional application No. 63/382,239, filed on Nov. 3, 2022.

(51) Int. Cl. H04W 72/232; H04L 5/00; H04W 72/1273

(52) U.S. Cl. CPC H04W 72/232; H04L 5/001; H04W 72/1273

(57) ABSTRACT

Various aspects of the present disclosure generally relate to wireless communication. In some aspects, a user equipment (UE) may receive a physical downlink control channel (PDCCH) monitoring configuration, the PDCCH monitoring configuration being associated with a set of downlink control information (DCI) formats for monitoring on a set of component carriers, the PDCCH monitoring configuration being associated with a split parameter for DCI monitoring or a hierarchy for DCI monitoring. The UE may monitor, on the set of component carriers, for DCI having a format from the set of DCI formats, the monitoring being based at least in part on the split parameter or the hierarchy. Numerous other aspects are described.

### CROSS-REFERENCE TO RELATED APPLICATION

This patent application claims priority to U.S. Provisional Patent Application No. 63/382,239, filed on Nov. 3, 2022, entitled “TECHNIQUES FOR MONITORING A PHYSICAL DOWNLINK CONTROL CHANNEL IN A MULTI-CELL SCHEDULING SCENARIO,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for monitoring a physical downlink control channel in a multi-cell scheduling scenario.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a physical downlink control channel (PDCCH) monitoring configuration, the PDCCH monitoring configuration being associated with a set of downlink control information (DCI) formats for monitoring on a set of component carriers, the PDCCH monitoring configuration being associated with a split parameter for DCI monitoring or a hierarchy for DCI monitoring. The method may include monitoring, on the set of component carriers, for DCI having a format from the set of DCI formats, the monitoring being based at least in part on the split parameter or the hierarchy.

Some aspects described herein relate to a UE for wireless communication. The UE may include one or more memories and one or more processors coupled to the one or more memories. The one or more processors may be configured to receive a PDCCH monitoring configuration, the PDCCH monitoring configuration being associated with a set of DCI formats for monitoring on a set of component carriers, the PDCCH monitoring configuration being associated with a split parameter for DCI monitoring or a hierarchy for DCI monitoring. The one or more processors may be configured to monitor, on the set of component carriers, for DCI having a format from the set of DCI formats, the monitoring being based at least in part on the split parameter or the hierarchy.

Some aspects described herein relate to a non-transitory computer-readable medium that stores a set of instructions for wireless communication by a UE. The set of instructions, when executed by one or more processors of the UE, may cause the UE to receive a PDCCH monitoring configuration, the PDCCH monitoring configuration being associated with a set of DCI formats for monitoring on a set of component carriers, the PDCCH monitoring configuration being associated with a split parameter for DCI monitoring or a hierarchy for DCI monitoring. The set of instructions, when executed by one or more processors of the UE, may cause the UE to monitor, on the set of component carriers, for DCI having a format from the set of DCI formats, the monitoring being based at least in part on the split parameter or the hierarchy.

Some aspects described herein relate to an apparatus for wireless communication. The apparatus may include means for receiving a PDCCH monitoring configuration, the PDCCH monitoring configuration being associated with a set of DCI formats for monitoring on a set of component carriers, the PDCCH monitoring configuration being associated with a split parameter for DCI monitoring or a hierarchy for DCI monitoring. The apparatus may include means for monitoring, on the set of component carriers, for DCI having a format from the set of DCI formats, the monitoring being based at least in part on the split parameter or the hierarchy.

Some aspects described herein relate to a method of wireless communication performed by a UE. The method may include receiving a PDCCH monitoring configuration, the PDCCH monitoring configuration being associated with a set of DCI formats for monitoring on a set of component carriers. The method may include monitoring, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold.

Some aspects described herein relate to a UE for wireless communication. The user equipment may include one or more memories and one or more processors coupled to the one or more memories. The one or more processors may be configured to receive a PDCCH monitoring configuration, the PDCCH monitoring configuration being associated with a set of DCI formats for monitoring on a set of component carriers. The one or more processors may be configured to monitor, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIGS. 4A and 4B are diagrams illustrating examples of downlink control information (DCI) based scheduling, in accordance with the present disclosure.

FIGS. 5A and 5B are diagrams illustrating an example of DCI size alignment, in accordance with the present disclosure.

FIGS. 6A and 6B are diagrams illustrating examples of downlink control channel monitoring, in accordance with the present disclosure.

FIG. 7 is a diagram illustrating an example of downlink control channel sizes, in accordance with the present disclosure.

FIGS. 8A-8D are diagrams illustrating an example associated with monitoring for a PDCCH in a multi-cell scheduling scenario, in accordance with the present disclosure.

FIGS. 9A-9B are diagrams illustrating an example associated with size alignment in a multi-cell scheduling scenario, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

### DETAILED DESCRIPTION

A user equipment (UE) may be configured to monitor a maximum quantity of downlink control information (DCI) sizes. For example, the UE may monitor 3 DCI sizes for a cell radio network temporary identifier (C-RNTI), a cell-specific radio network temporary identifier (CS-RNTI), and/or a modulation and coding scheme C-RNTI (MCS-C-RNTI) and 1 additional DCI size for other radio network temporary identifiers (RNTI). This example configuration of a UE may be referred to as a “3+1” DCI size budget, as described in more detail herein.

A DCI may be associated with a carrier indicator field (CIF) value that may correspond to a carrier on which the DCI is scheduling. The cell on which the DCI is received may be referred to as a “scheduling cell,” and the cell that the DCI is scheduling may be referred to as a “scheduled cell.” Each CIF value may be associated with a different cell in a one-to-one mapping, such as a first CIF value mapping to a first cell, a second CIF value mapping to a second cell, and a third CIF value mapping to a third cell. Each cell and each CIF value may have a separate maximum configured quantity of blind decodes (BDs), control channel elements (CCEs), and/or DCI sizes. Accordingly, each CIF value may be associated with a separate 3+1 DCI size budget.

However, when a plurality of types of DCI formats, as described in more detail herein, are configured in a network, a component carrier may be associated with more DCI sizes than is permitted. For example, a component carrier may be associated with 3 DCI sizes for a first type of DCI format and 2 DCI sizes for a second type of DCI format. When a component carrier is overbudget (e.g., can be associated to more DCI sizes than are allowed under a DCI size budget), a UE may not be successful in decoding DCI.

Some aspects described herein enable multi-cell scheduling by a single DCI without violating a DCI size budget. For example, a UE may report a split ratio parameter (or other splitting parameter) which may correspond to a quantity of blind decodes between different formats of DCI that the UE can support. The UE may be configured for blind decoding using the split ratio and may perform monitoring using the configuration for blind decoding and/or based at least in part on an indication to perform monitoring. In this way, by introducing the split ratio, the UE and a network node can avoid a component carrier overbudget issue, thereby ensuring successful blind decoding. Additionally, or alternatively, blind decodes can be divided into a hierarchically structured set of groups based on a rule or configuration. In this case, the set of groups enable limiting of blind decodes, thereby avoiding a component carrier overbudget issue, as described in more detail herein. Additionally, or alternatively, the UE can perform a size alignment procedure, as described herein, to ensure that a component carrier is not overbudget with regard to a quantity of different DCI formats that the UE is to monitor, thereby avoiding a component carrier overbudget issue.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

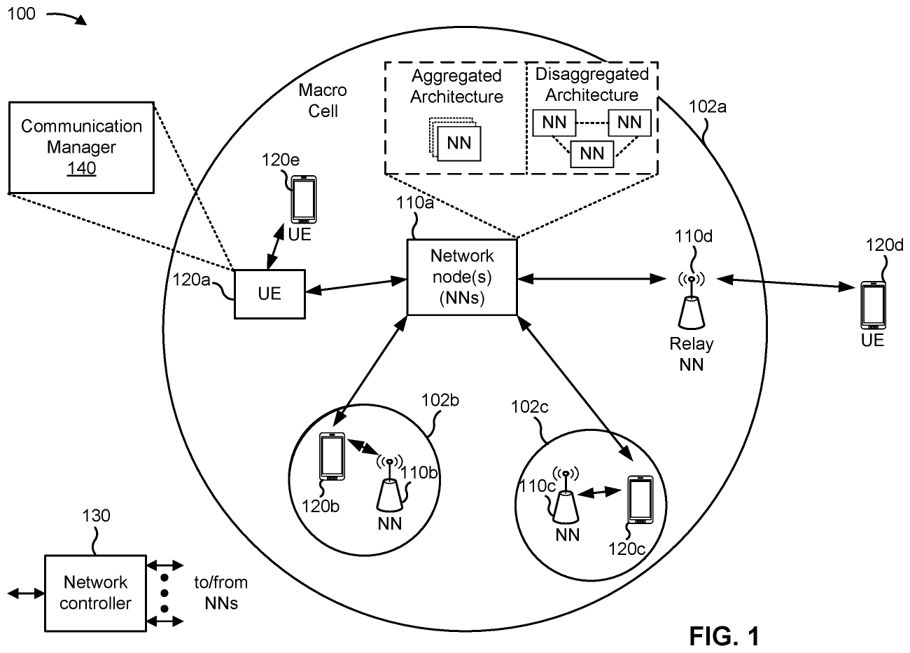

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a physical downlink control channel (PDCCH) monitoring configuration, the PDCCH monitoring configuration being associated with a set of downlink control information (DCI) formats for monitoring on a set of component carriers, the PDCCH monitoring configuration being associated with a split parameter for DCI monitoring or a hierarchy for DCI monitoring; and monitor, on the set of component carriers, for DCI having a format from the set of DCI formats, the monitoring being based at least in part on the split parameter or the hierarchy. In some aspects, the communication manager 140 may receive a PDCCH monitoring configuration, the PDCCH monitoring configuration being associated with a set of DCI formats for monitoring on a set of component carriers; and monitor, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold. Additionally, or alternatively, the communication manager 140 may perform one or more other operations described herein.

As indicated above, FIG. 1 is provided as an example. Other examples may differ from what is described with regard to FIG. 1.

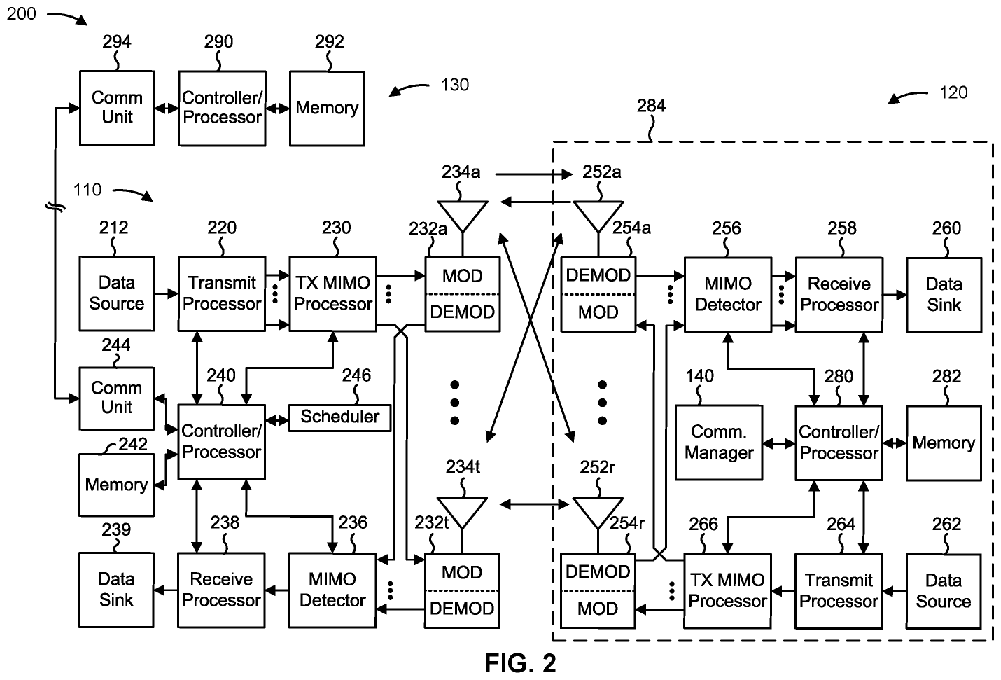

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

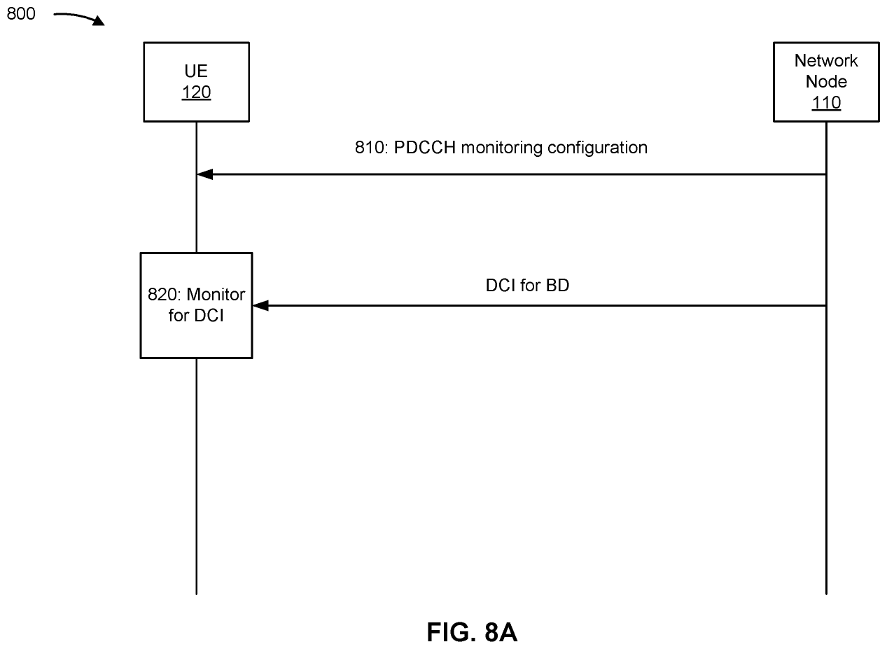

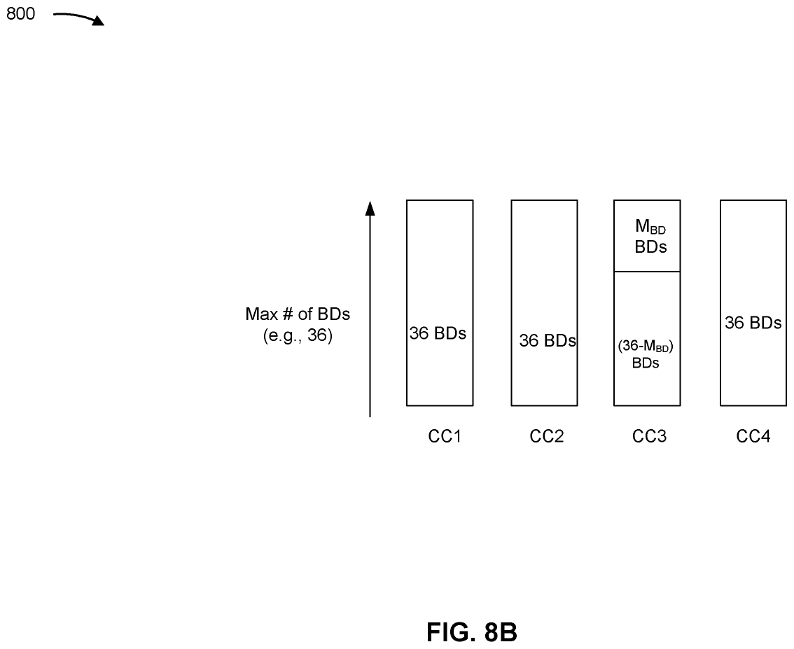

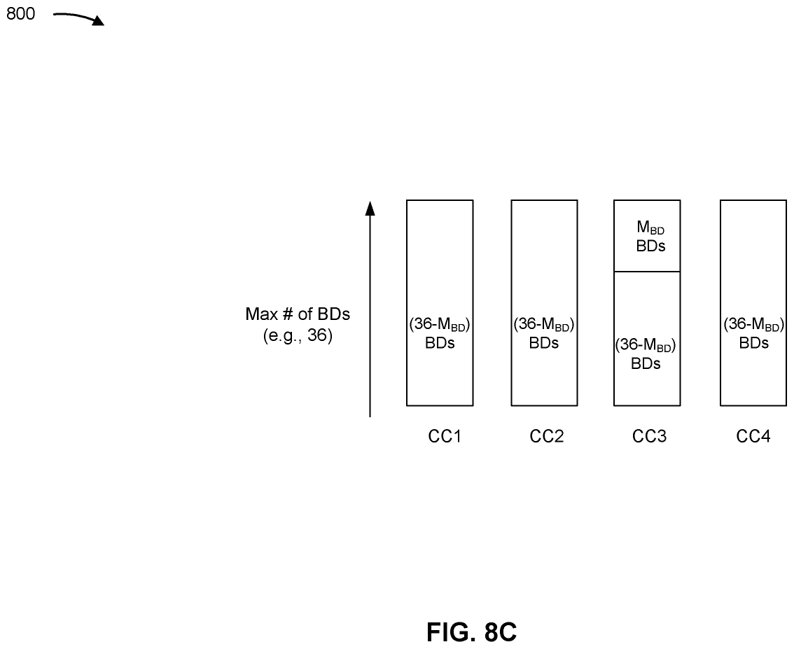

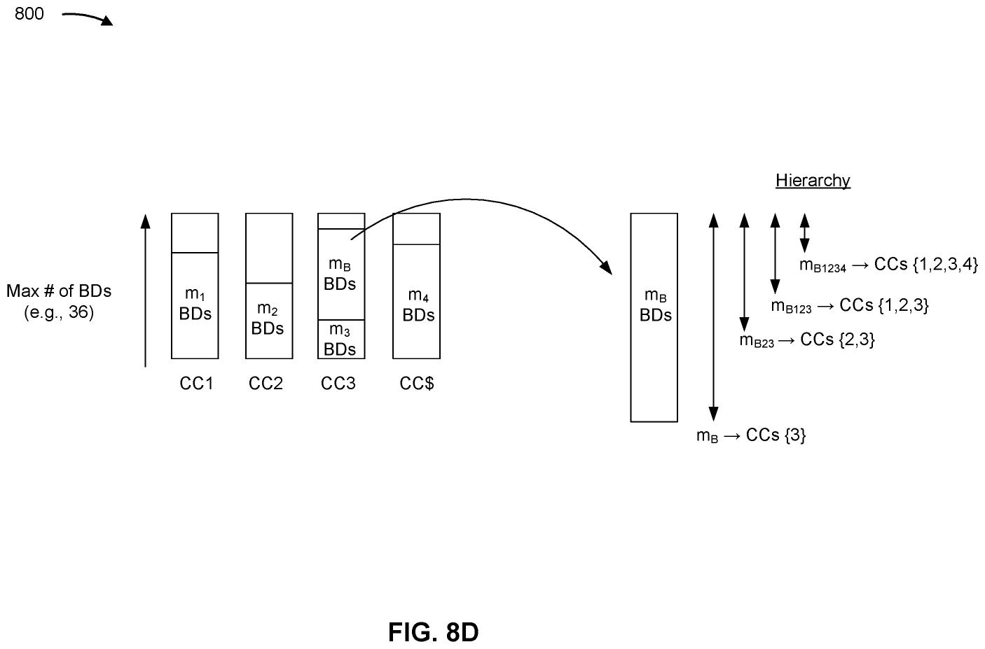

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 8A-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 8A-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

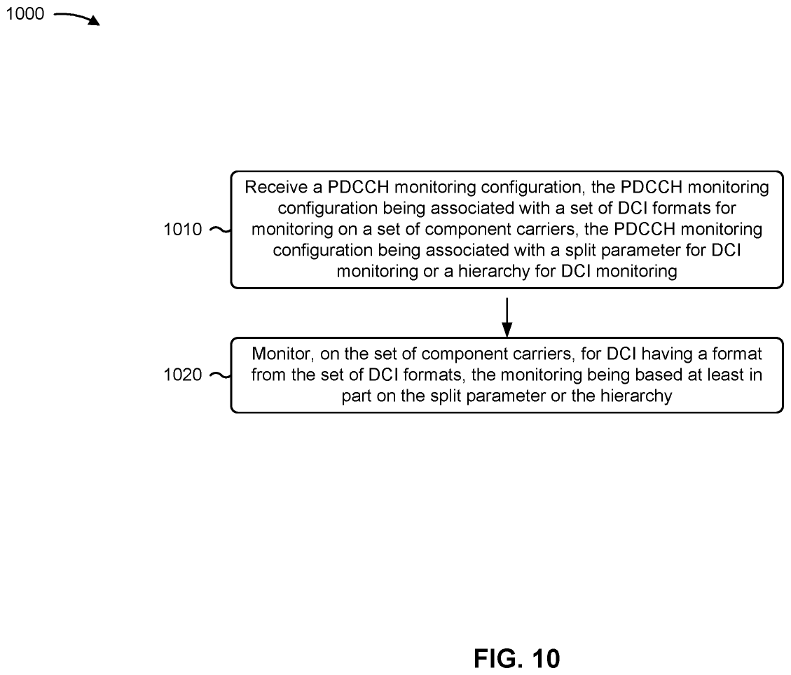

The controller/processor 240 of the network node 110, the controller/processor 280 of the UE 120, or any other component(s) of FIG. 2 may perform one or more techniques associated with monitoring a PDCCH in a multi-cell scheduling scenario, as described in more detail elsewhere herein. For example, the controller/processor 240 of the network node 110, the controller/processor 280 of the UE 120, or any other component(s) (or combinations of components) of FIG. 2 may perform or direct operations of, for example, process 1000 of FIG. 10 and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10 and/or other processes as described herein. In some examples, executing instructions may include running the instructions, converting the instructions, compiling the instructions, and/or interpreting the instructions, among other examples.

In some aspects, the UE 120 includes means for receiving a PDCCH monitoring configuration, the PDCCH monitoring configuration being associated with a set of DCI formats for monitoring on a set of component carriers, the PDCCH monitoring configuration being associated with a split parameter for DCI monitoring or a hierarchy for DCI monitoring; and/or means for monitoring, on the set of component carriers, for DCI having a format from the set of DCI formats, the monitoring being based at least in part on the split parameter or the hierarchy. In some aspects, the UE 120 includes means for receiving a PDCCH monitoring configuration, the PDCCH monitoring configuration being associated with a set of DCI formats for monitoring on a set of component carriers; and means for monitoring, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

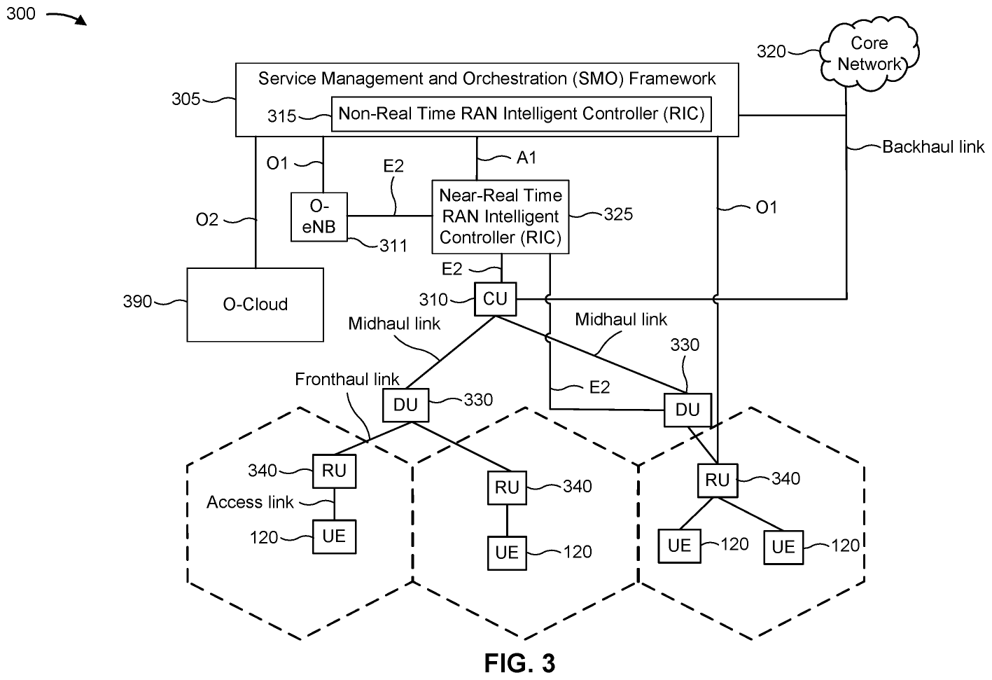

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

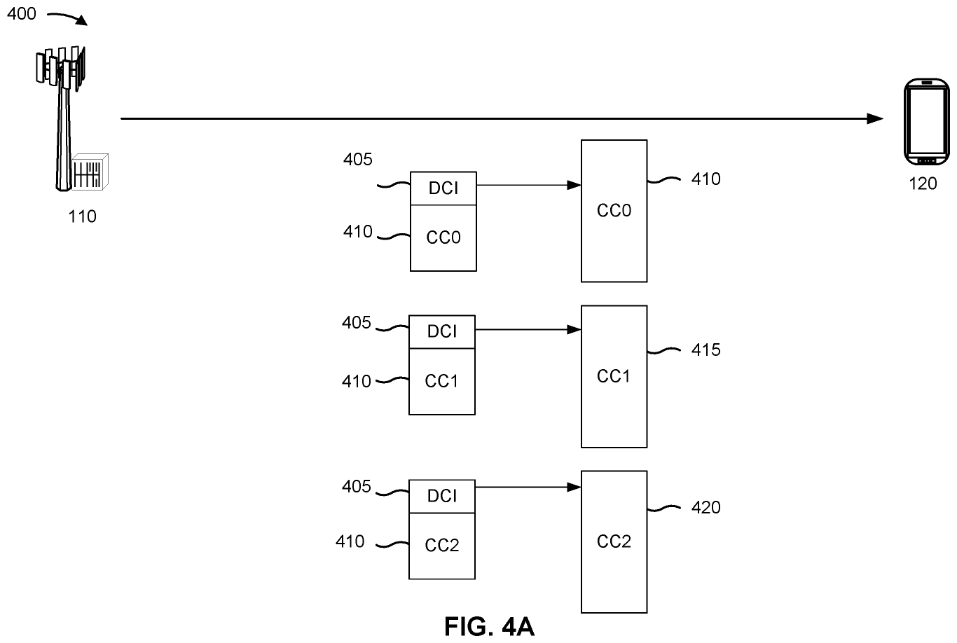

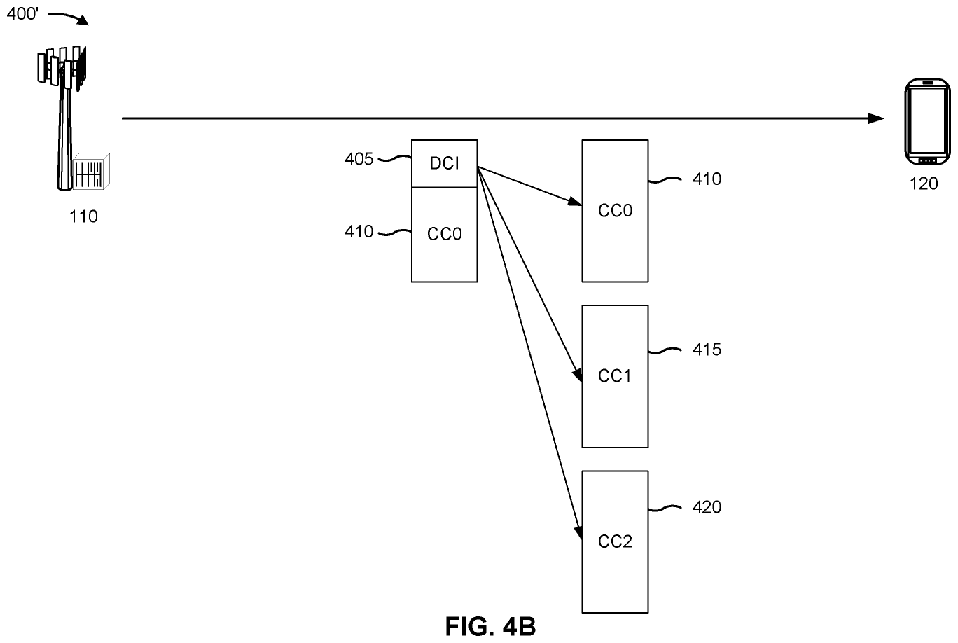

FIGS. 4A and 4B are diagrams illustrating examples 400/400′ of DCI based scheduling, in accordance with the present disclosure. As shown in FIGS. 4A and 4B, a network node 110 and a UE 120 may communicate with one another (e.g., directly or via one or more network nodes).

As shown in FIG. 4A, as an example 400 of self-scheduling, the network node 110 may transmit a set of DCIs 405 that schedule communications for the UE 120. The communications may be scheduled on the same cells on which the set of DCIs 405 are conveyed. In some cases, a cell may be referred to as a component carrier (CC). For example, as shown, a first DCI 405 schedules a communication for a first cell 410 that carries the first DCI 405 (show as CC0), a second DCI 405 schedules a communication for a second cell 415 that carries the second DCI 405 (shown as CC1), and a third DCI 405 schedules a communication for a third cell 420 carries the third DCI 405 (shown as CC2).

As shown in FIG. 4B, the network node 110 may transmit, to the UE 120 (e.g., directly or via one or more network nodes), a single DCI 405 that schedules a plurality of communications for the UE 120. The plurality of communications may be scheduled for at least two different cells. In some cases, DCI that schedules a communication for a cell via which the DCI is transmitted may be referred to as self-carrier (or self-cell) scheduling DCI. In some cases, DCI that schedules a communication for a cell via which the DCI is transmitted may be referred to as cross-carrier (or cross-cell) scheduling DCI. In some aspects, the DCI 405 may be cross-carrier scheduling DCI, and may or may not be self-carrier scheduling DCI. In some cases, the DCI 405 that carries communications in at least two cells may be referred to as combination DCI.

In example 400′, the single DCI 405 schedules a communication for a first cell 410 that carries the DCI 405 (shown as CC0), schedules a communication for a second cell 415 that does not carry the DCI 405 (shown as CC1), and schedules a communication for a third cell 420 that does not carry the DCI 405 (shown as CC2). In some cases, the DCI 405 may schedule communications on a different number of cells than shown in FIG. 4B (e.g., two cells, four cells, five cells, and so on). The number of cells may be greater than or equal to two.

A communication scheduled by DCI 405 may include a data communication, such as a physical downlink shared channel (PDSCH) communication or a physical uplink shared channel (PUSCH) communication. For a data communication, DCI 405 may schedule a single transport block (TB) across a plurality of cells or may separately schedule a plurality of TBs in the plurality of cells. Additionally, or alternatively, a communication scheduled by DCI 405 may include a reference signal, such as a channel state information (CSI) reference signal (RS) (CSI-RS) or a sounding reference signal (SRS). For a reference signal, DCI 405 may trigger a single resource for reference signal transmission across multiple cells or may separately schedule multiple resources for reference signal transmission in the multiple cells. In some cases, scheduling information in DCI 405 may be indicated once and reused for multiple communications (e.g., on different cells), such as a modulation and coding scheme (MCS), a resource to be used for acknowledgement (ACK) or negative acknowledgement (NACK) of a communication scheduled by DCI 405, and/or a resource allocation for a scheduled communication, to conserve signaling overhead.

In a self-scheduling use case, as shown in FIG. 4A, each DCI may have a configured maximum quantity M of blind decodes (BDs) and a configured maximum quantity C of CCEs. In some cases, M and C may be fixed values and/or the same value. In other cases, M and C may have changing values and/or be different values. For example, the values for M and C may be based at least in part on a quantity of carriers in a carrier aggregation configuration, a quantity of subcarrier spacings of carriers in a carrier aggregation configuration, or a UE capability for PDCCH processing, among other examples. Accordingly, when a value for one or more of the above-mentioned factors changes, the values for M and/or C may change.

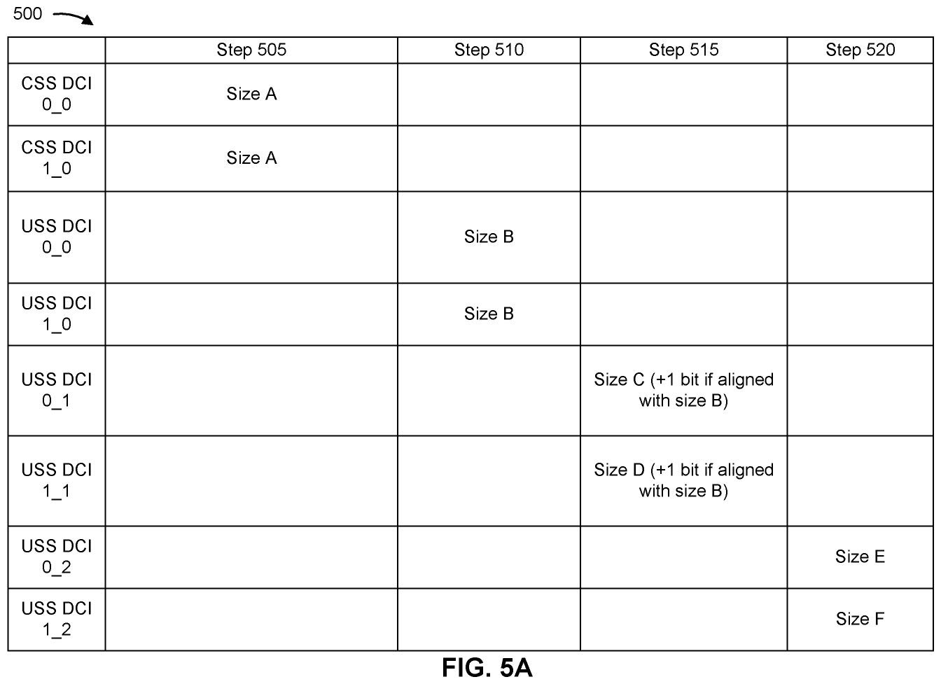

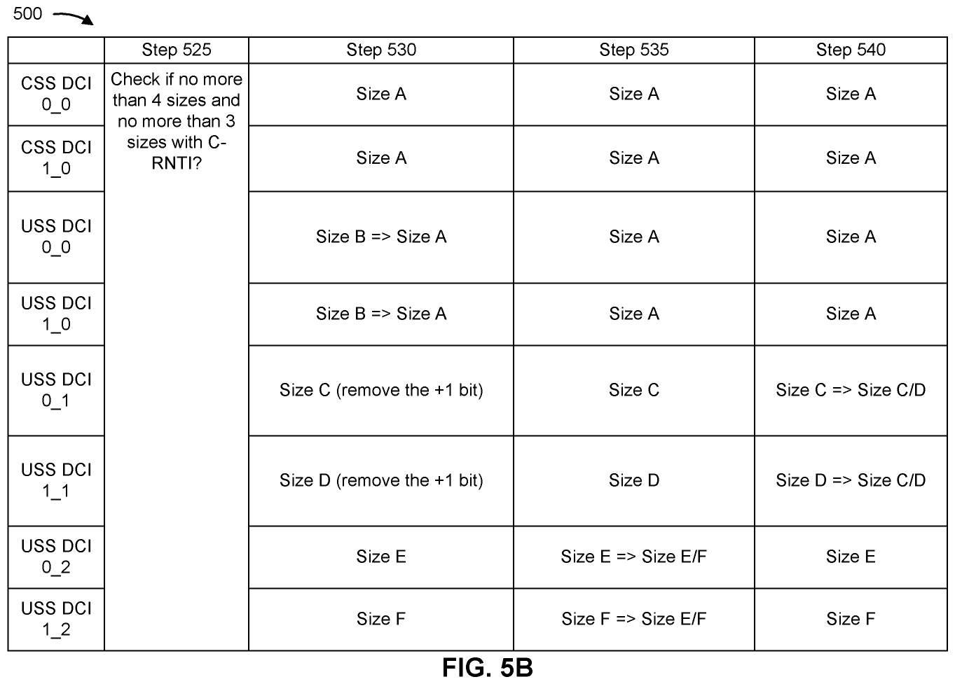

Each DCI can be configured with up to a maximum quantity N of DCI formats. For example, the first DCI 405 may have up to 4 DCI formats (e.g., selected from DCI formats 0_0, 1_0, 0_1, 1_1, or 0_2, 1_2) and up to 3+1 DCI sizes, as described in more detail with regard to FIGS. 5A and 5B. In contrast, the third DCI 405 may have PDCCH overbooking (OB) enabled and may have up to 6 DCI formats (e.g., selected from the aforementioned DCI formats) and up to 3+1 DCI sizes. Different types of DCI formats may be possible, such as a first type of DCI format, which has been specified in 3GPP Release 16 (Rel. 16), such as DCI formats 0_0, 1_0, 0_1, 1_1, or 0_2, 1_2, among other examples. A second type of DCI format has been proposed for 3GPP Release 18 (Rel. 18), such as DCI formats 0_X or 1_X, among other examples. In some cases, the first type of DCI format may be referred to as a “legacy DCI format” and the second type of DCI format may be referred to as a “non-legacy DCI format” or a “Rel-18 DCI format.” In a cross-carrier scheduling case, the DCI 405 may be associated with a carrier indicator field (CIF) value n_{CI}. Each CIF value may correspond to a cell that the DCI 405 is scheduling. For example, with regard to FIG. 4A, each DCI in each component carrier may be associated with a CIF value associated with up to M BDs and up to C CCEs. Similarly, with regard to FIG. 4B, CC0 may convey one or more DCI with one or more CIF values. For example, CC0 may convey 3 DCI messages with 3 CIF values corresponding to the 3 component carriers that are being scheduled. In this case, each CIF value and corresponding DCI may be associated with up to M BDs and up to C CCEs. Further, each CIF value and corresponding DCI may be associated with a maximum quantity of DCI formats, such as up to 4 DCI formats for a first CIF value and first corresponding DCI and up to 6 DCI formats for a second CIF value and second corresponding DCI. A UE, such as the UE 120, may determine a quantity of PDCCH candidates, for each aggregation level, that are to be monitored in a search space with a particular identifier based at least in part on a search space set configuration for a bandwidth part. The search space set configuration may indicate a BD or CCE limit on a per scheduled cell basis. Additional details regarding search space sets and associated CCEs are provided with regard to 3GPP Technical Specification (TS) 38.213 Rel. 16, version 16.11.0, section 10.1.

As indicated above, FIGS. 4A and 4B are provided as examples. Other examples may differ from what is described with respect to FIGS. 4A and 4B.

FIGS. 5A and 5B are diagrams illustrating an example 500 of DCI size alignment, in accordance with the present disclosure.

As shown in FIG. 5A, and by step 505, a UE, such as the UE 120, may determine a first size, Size A, for a common search space (CSS) DCI 0_0 and for a CSS DCI 1_0 (if CSS DCI 0_0 or CSS DCI 1_0 are configured, respectively). In some cases, the UE may align the CSS DCI 0_0 to a size of the CSS DCI 1_0. For example, when the CSS DCI 00 has a larger size than the CSS DCI 1_0, the UE may add a set of zero padding bits to the CSS DCI 0_0 until the payload size is equal to that of the DCI 1_0. In contrast, if the CSS DCI 0_0 has a smaller size than the CSS DCI 1_0 prior to truncation, the UE may reduce the bitwidth of the frequency domain resource assignment (FDRA) field in the DCI 0_0 by truncating the first few most significant bits such that the size of DCI 0_0 equals to the size of the DCI 1_0.

As further shown in FIG. 5A, and by step 510, the UE may determine a second size, Size B, for a UE-specific search space (USS) DCI 00 and a USS DCI 1_0 (if USS DCI 0_0 or USS DCI 1_0 are configured, respectively). In some cases, the UE may align the USS DCI 0_0 and the USS DCI 1_0 to a common size by adding padding bits to a smaller one of the USS DCI 0_0 and the USS DCI 1_0.

As further shown in FIG. 5A, and by step 515, the UE may determine a third size, Size C, for a USS DCI 0_1 and a fourth size, Size D, for a USS DCI 1_1 (if USS DCI 0_1 or USS DCI 1_1 are configured, respectively). In some cases, the UE may determine Size C and/or Size D based at least in part on Size B. For example, the UE may set Size C and/or Size D as one bit greater than Size B.

As further shown in FIG. 5A, and by step 520, the UE may determine a fifth size, Size E, for a USS DCI 0_2 and a sixth size, Size F, for a USS DCI 1_2 (if USS DCI 0_2 or USS DCI 1_2 are configured, respectively).

As shown in FIG. 5B, and by step 525, the UE may determine whether a size threshold is satisfied. For example, based at least in part on which DCIs are configured for the UE, the UE may determine a quantity of DCI sizes. In other words, if CSS DCI 0_0 (Size A), CSS DCI 1_0 (Size A), USS DCI 0_1 (Size C), and USS DCI 0_2 (Size E) are configured, then there are three DCI sizes. In contrast, if CSS DCI 0_0 (Size A), USS DCI 0_0 (Size B), USS DCI 0_1 (Size C), and USS DCI 0_2 (Size E) are configured, then there are four DCI sizes. Based at least in part on determining the quantity of DCI sizes, the UE may determine whether there are more than 4 DCI sizes or more than 3 DCI sizes with a C-RNTI configured. If neither DCI size threshold is satisfied, then the UE may proceed without performing further steps of DCI size alignment. However, if either DCI size threshold is satisfied, then the UE may perform further steps of DCI size alignment, as described herein with regard to FIG. 5B and steps 530-540.

As further shown in FIG. 5B, and by step 530, the UE may perform a first set of size alignment actions. For example, the UE may maintain CSS DCI 0_0 and CSS DCI 1_0 (if configured) at Size A; the UE may align USS DCI 0_0 and/or USS DCI 1_0 (if configured) to Size A (e.g., using padding bits or truncating existing bits); the UE may remove the added bit in USS DCI 0_1 and USS DCI 1_1 (if configured) that was added with regard to step 515, and the UE may maintain a size of USS DCI 0_2 and USS DCI 1_2 (if configured).

As further shown in FIG. 5B, and by step 535, the UE may perform a second set of alignment actions. For example, the UE may maintain CSS DCI 0_0, CSS DCI 1_0, USS DCI 0_0, USS DCI 1_0, USS DCI 0_1, and USS DCI 1_1 (if configured); and may align USS DCI 0_2 with USS DCI 1__2 (if configured) by adding padding bits to one or the other to cause USS DCI 0_2 and USS DCI 1_2 to have a common size (e.g., Size E or Size F).

As further shown in FIG. 5B, and by step 540, the UE may perform a third set of alignment actions. For example, the UE may maintain CSS DCI 0_0, CSS DCI 1_0, USS DCI 0_0, USS DCI 1_0, USS DCI 0_2, and USS DCI 1_2 (if configured); and may align USS DCI 0_1 with USS DCI 1__1 (if configured) by adding padding bits to one or the other to cause USS DCI 0_1 and USS DCI 1_1 to have a common size (e.g., Size C or Size D). In some cases, the UE may repeat the check of step 525 after each of steps 530, 535, and 540. In other cases, the UE may perform multiple of steps 530, 535, and/or 540 before repeating the check of step 525. After performing the size alignment procedure, the UE ensures that the DCI size thresholds are satisfied, which enables the UE to successfully monitor for the configured DCIs.

As indicated above, FIGS. 5A and 5B are provided as examples. Other examples may differ from what is described with respect to FIGS. 5A and 5B.

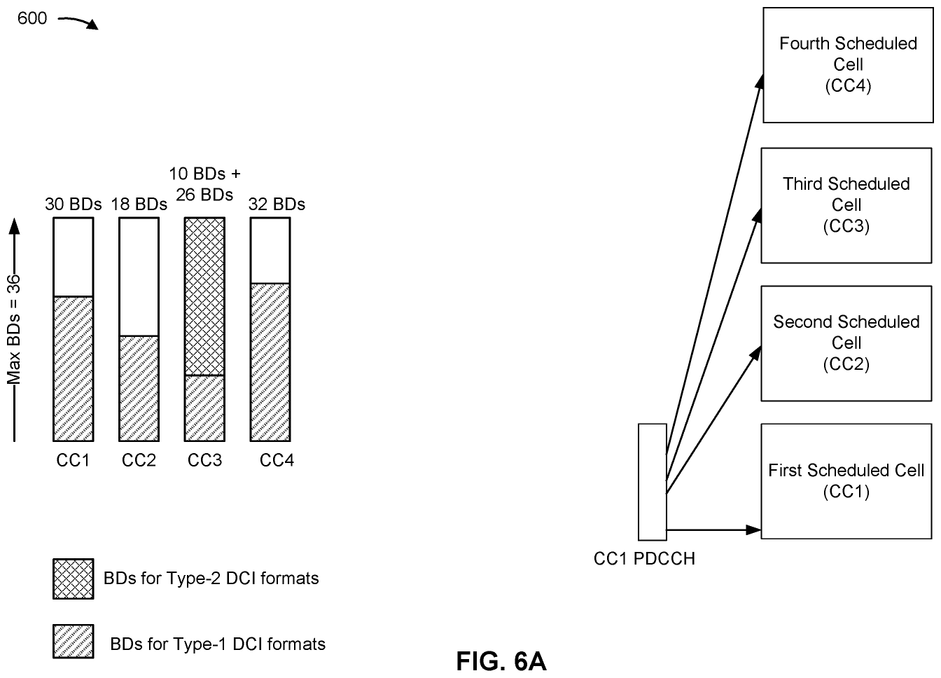

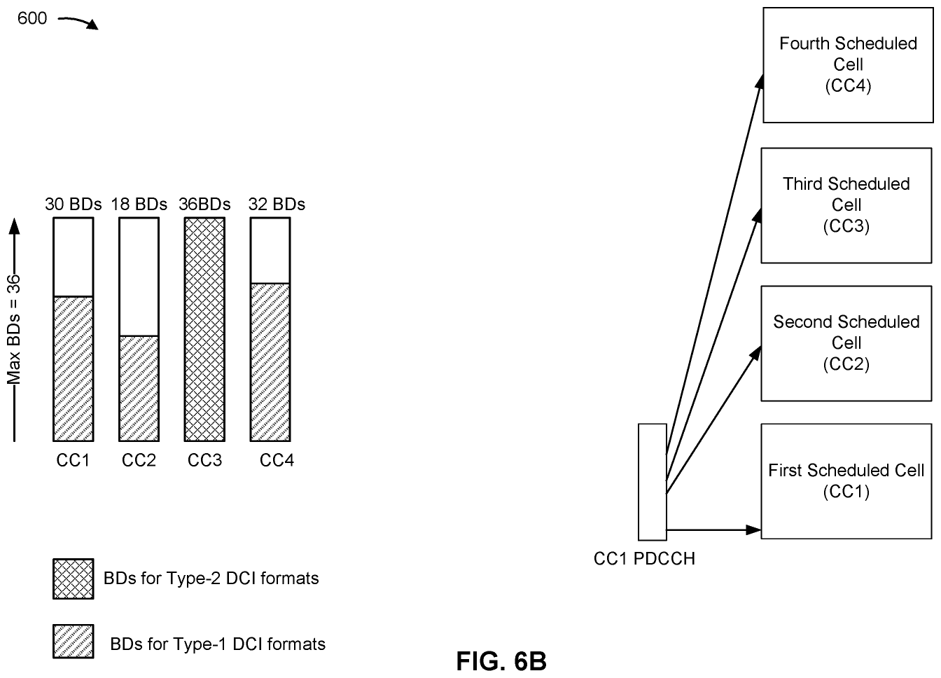

FIGS. 6A-6B are diagrams illustrating examples 600 of downlink control channel monitoring, in accordance with the present disclosure.

For non-carrier aggregation (non-CA) scenarios, a UE may be configured with a maximum quantity of BDs or non-overlapped CCEs, which may be referred to as a BD budget or a CCE budget, respectively. For example, 3GPP TS 38.213, Tables 10.1-2 and 10.1-3 indicate a maximum quantity of monitored PDCCH candidates and non-overlapped CCEs, respectively, per slot and per serving cell. The maximum quantities of BDs and non-overlapped CCEs may be based at least in part on a subcarrier spacing (SCS) configuration for a serving cell. For example, for an SCS configuration μ=1, a UE (e.g., the UE 120) may be configured with a BD budget of 36 BDs per scheduled cell and a CCE budget of 56 CCEs per scheduled cell. For CA scenarios, the BD budget per SCS, M_{PDCCH}^{total,slot,μ}, the CCE budget per SCS, C_{PDCCH}^{total,slot,μ} are configured as described in TS 38.213, Section 10.1. Similarly, the BD budget and CCE budget per cell or component carrier may be min(M_{PDCCH}^{max,slot,μ}, M_{PDCCH}^{total,slot,μ}) and min(C_{PDCCH}^{max,slot,μ}, C_{PDCCH}^{total,slot,μ}), respectively.

The aforementioned BD and CCE budgets are configured with an assumption of a single type of DCI format, such as a legacy DCI format. However, with an introduction of non-legacy DCI formats, the aforementioned BD and CCE budgets may be exceeded in some cases. For example, a UE may have, for monitoring, legacy DCI formats for each CC and non-legacy DCI formats for one or more CCs. As an example, as shown in FIG. 6A, a PDCCH in CC1 schedules data on one or more CCs of a set of CCs (CC1, CC2, CC3, and CC4). The UE may monitor the legacy DCI formats for each CC resulting in 30 BDs on CC1, 18 BDs on CC2, 10 BDs on CC3 and 32 BDs on CC4. Additionally, the UE may monitor for non-legacy DCI formats with a BD budget being counted on CC3, resulting in another 26 BDs. Accordingly, each CC is associated with fewer than a maximum 36 BDs in accordance with a particular SCS configuration, as shown in FIG. 6A. However, it is possible that the UE will assume that a network node can schedule, and the UE may need to monitor for, 26 BDs associated with non-legacy DCI formats on each CC, which may result in each CC other than CC3 having more than the maximum 36 BDs. Similarly, in FIG. 6B, 36 BDs may be for legacy DCI formats on CC1, CC2, and CC4, and 36 BDs may be for non-legacy DCI formats on CC3. In such an example, the UE may need to monitor for 36 BDs associated with the non-legacy DCI formats on CC1, CC2, and CC4, in addition to monitoring for 36 BDs associated with legacy DCI formats. As a result, the UE may need to monitor for more than the configured maximum quantity of BDs. Some UEs may not have a monitoring capability for these additional BDs.

As indicated above, FIGS. 6A-6B are provided as examples. Other examples may differ from what is described with respect to FIGS. 6A-6B.

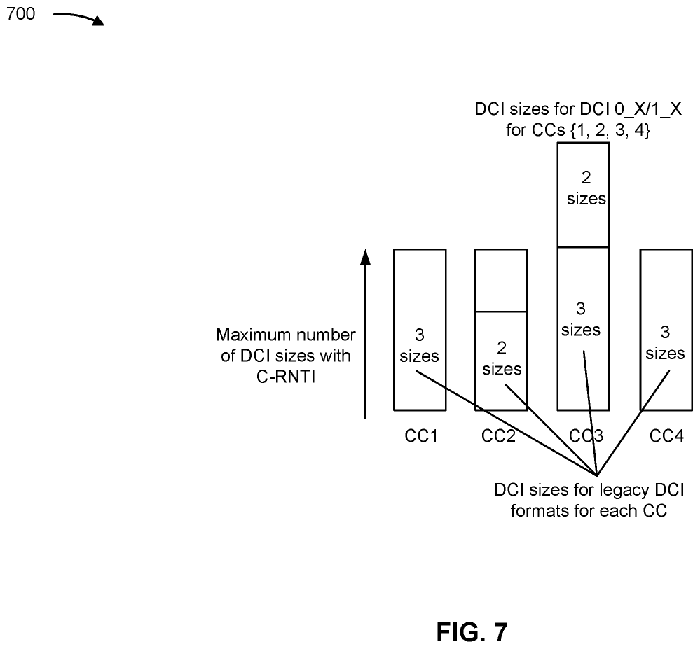

FIG. 7 is a diagram illustrating an example 700 of downlink control channel sizes, in accordance with the present disclosure.

As described above, a UE may be configured to monitor a maximum quantity of DCI sizes. For example, the UE may monitor 3 DCI sizes for a cell radio network temporary identifier (C-RNTI), a cell-specific radio network temporary identifier (CS-RNTI), and/or an MCS-C-RNTI and 1 additional DCI size for other radio network temporary identifiers (RNTI). Additional details of this “3+1” DCI size budget and DCI size alignment are described with regard to 3GPP Technical Specification (TS) 38.212, Section 7.3.1.0.

A DCI may be associated with a CIF value that may correspond to a carrier on which the DCI is scheduling. The cell on which the DCI is received may be referred to as a “scheduling cell,” and the cell that the DCI is scheduling may be referred to as a “scheduled cell.” Each CIF value may be associated with a different cell in a one-to-one mapping, such as a first CIF value mapping to a first cell, a second CIF value mapping to a second cell, and a third CIF value mapping to a third cell. Each cell and each CIF value may have a separate maximum configured quantity of BDs, CCEs, and/or DCI sizes. Accordingly, each CIF value may be associated with a separate 3+1 DCI size budget.

Other DCI size budgets may be used. For example, as shown in FIG. 7, a maximum quantity of DCI sizes associated with a C-RNTI may be 3 DCI sizes. However, when the second type of DCI formats, as described above, are configured in a network, a component carrier may be associated with more DCI sizes than is permitted. For example, as shown in FIG. 7, component carrier 3 may be associated with 3 DCI sizes for the first type of DCI format and 2 DCI sizes for the second type of DCI format. In another example, each component carrier may be configured to use the second type of DCI format. In this example, the first, third, and fourth component carriers may have 5 DCI sizes and the second component carrier may have 4 DCI sizes. As a result, each component carrier may be over-budget.

As indicated above, FIG. 7 is provided as an example. Other examples may differ from what is described with respect to FIG. 7.

FIGS. 8A-8D are diagrams illustrating an example 800 associated with monitoring for a PDCCH in a multi-cell scheduling scenario, in accordance with the present disclosure. As shown in FIG. 8A, example 800 includes communication between a network node 110 and a UE 120.

As further shown in FIG. 8A, and by reference number 810, the UE 120 may receive a PDCCH communication from the network node 110. For example, the UE 120 may receive a PDCCH monitoring configuration. In some aspects, the monitoring configuration may be associated with a set of DCI formats for monitoring on a set of component carriers. For example, the UE 120 may receive information in the PDCCH monitoring configuration, such as one or more parameters, from which the UE 120 may determine a set of component carriers to monitor, a set of formats to monitor, or a set of BDs to perform in connection with monitoring. Additionally, or alternatively, the UE 120 may receive information in the PDCCH monitoring configuration associated with identifying a split parameter or a hierarchy for DCI monitoring.

In some aspects, the split parameter may include a split ratio α that is associated with a quantity of BDs or (overlapping) CCEs that the UE 120 is to monitor for DCI with a legacy format or a non-legacy format counted on the same cell. For example, on the cell where BDs or CCEs for non-legacy DCI formats are counted, such as CC3 in FIG. 8B, the maximum quantity of BDs, q, for the non-legacy DCI formats is determined based at least in part on an equation of the form:

q₁₈=└α·min(M_{PDCCH}^{max,slot,μ},M_{PDCCH}^{total,slot,μ})┘=M_{BD}

where q₁₈ is the maximum quantity of BDs for non-legacy DCI formats (e.g., DCI formats 0_X and 1_X), α is the split ratio, M_{PDCCH}^{max,slot,μ} is a maximum quantity of monitored PDCCH candidates per slot for a downlink bandwidth part with an SCS configuration μ, M_{PDCCH}^{total,slot,μ} is a total quantity of monitored PDCCH candidates per slot for a downlink bandwidth part with an SCS configuration μ, and M_{BD} is another manner of denoting q₁₈. In some aspects, rather than a ratio value for α, the UE 120 may be configured with an absolute value (e.g., a quantity of BDs as a value for M_{BD}). Similarly, in this case, a maximum quantity of BDs for legacy DCI formats is determined based at least in part on an equation of the form:

q₁₆=min(M_{PDCCH}^{max,slot,μ},M_{PDCCH}^{total,slot,μ})−└α·min(M_{PDCCH}^{max,slot,μ},M_{PDCCH}^{total,slot,μ})┘

where q₁₆ is the maximum quantity of BDs for legacy DCI formats. In some aspects, PDCCH overbooking may not be configured for the UE 120 for non-legacy DCI formats. For example, the network node 110 may configure PDCCH monitoring for non-legacy DCI formats such that a quantity of BDs does not exceed the aforementioned configured value. In some aspects, PDCCH overbooking is configured for the UE 120 for legacy DCI formats. For example, the network node 110 may configure the UE 120 to forgo monitoring for one or more PDCCH candidates or SS sets if the quantity of BDs for legacy DCI formats on a cell would exceed q₁₆. In some aspects, the UE 120 may determine a maximum quantity of BDs on one or more other cells (e.g., for which non-legacy DCI formats are not monitored) as q₁₆=min(M_{PDCCH}^{max,slot,μ},M_{PDCCH}^{total,slot,μ}). Accordingly, as shown in FIG. 8B, the UE 120 may be configured for 36 BDs on CC1, 36 BDs on CC2, M_{BD}) BDs for non-legacy DCI formats and (36-M_{BD})) BDs for legacy DCI formats on CC3, and 36 BDs on CC4.

In some aspects, the UE 120 may transmit capability signaling. For example, the UE 120 may transmit information indicating a supported value for the split ratio and may receive the PDCCH monitoring configuration based at least in part on indicating the supported value for the split ratio. In this case, the network node 110 may provide confirmation of the value for the split ratio in the PDCCH monitoring configuration or may indicate a value for the split ratio to achieve a lower decoding complexity than is indicated by the UE capability. In other words, the network node 110 may reduce decoding complexity to less than a UE capability in some cases, such as based at least in part on a network condition or a presence of other UEs on the network.

In some aspects, the UE 120 may determine a split ratio for non-overlapping CCEs. For example, for BDs and non-overlapping CCEs on a cell where the BDs and non-overlapping CCEs for non-legacy DCI formats are configured (e.g., CC3 in FIG. 8B), a maximum quantity of BDs for non-legacy DCI formats is q₁₈=└α·min(M_{PDCCH}^{max,slot,μ},M_{PDCCH}^{total,slot,μ})┘ and a maximum number of non-overlapping CCEs for the non-legacy DCI formats (r₁₈) is r₁₈=└α·min(C_{PDCCH}^{max,slot,μ},C_{PDCCH}^{total,slot,μ})┘. Similarly, the maximum quantity of BDs for legacy DCI formats is q₁₈=min(M_{PDCCH}^{max,slot,μ},M_{PDCCH}^{total,slot,μ})−└α·min(M_{PDCCH}^{max,slot,μ},M_{PDCCH}^{total,slot,μ})┘ and the maximum quantity of non-overlapping CCEs for legacy DCI formats is r₁₈=min(C_{PDCCH}^{max,slot,μ},C_{PDCCH}^{total,slot,μ})−└α·min(C_{PDCCH}^{max,slot,μ},C_{PDCCH}^{total,slot,μ})┘.

In this case, for other cells in the same set (e.g., cells other than the component carrier on which the non-legacy DCI formats are configured), a maximum quantity of BDs is min(M_{PDCCH}^{max,slot,μ},M_{PDCCH}^{total,slot,μ}) and a maximum quantity of non-overlapping CCEs is min(C_{PDCCH}^{max,slot,μ},C_{PDCCH}^{total,slot,μ}). In some aspects, the UE 120 may apply the split ratio α to other CCs. For example, for the other cells in the same set and for overlapping CCEs, a maximum quantity of BDs is min(M_{PDCCH}^{max,slot,μ},M_{PDCCH}^{total,slot,μ})−[α·min(M_{PDCCH}^{max,slot,μ},M_{PDCCH}^{total,slot,μ})]. Similarly, for non-overlapping CCEs, the maximum quantity of BDs on the other cells in the set is min(M_{PDCCH}^{max,slot,μ},M_{PDCCH}^{total,slot,μ})−└α·min(M_{PDCCH}^{max,slot,μ},M_{PDCCH}^{total,slot,μ})┘ and the maximum quantity of non-overlapping CCEs is min(C_{PDCCH}^{max,slot,μ},C_{PDCCH}^{total,slot,μ})−└α·min(C_{PDCCH}^{max,slot,μ},C_{PDCCH}^{total,slot,μ})┘. With regard to the overlapping CCE example, and as shown in FIG. 8C with M_{BD} representing the term “└α·min(M_{PDCCH}^{max,slot,μ},M_{PDCCH}^{total,slot,μ})┘”, the quantity of BDs on CC1, CC2, and CC4 is 36−M_{BD} BDs. As a result, if the UE 120 reports, as a capability, M_{B}=10, the UE 120 will have, as a maximum, 26+10=36 BDs on each CC. Similarly, if the UE 120 reports, as a capability, M_{B}=24, the UE 120 will have, as a maximum, 12+24=36 BDs on each CC. By altering a value that is signaled in UE capability signaling to the network node 110 for MB, the UE 120 may control a decoding complexity.

In some aspects, the UE 120 may be configured with a hierarchy for BDs. For example, a set of BDs for non-legacy DCI formats may be divided into a hierarchical structure of sub-groups. In some aspects, the hierarchical structure may be based at least in part on a rule. For example, the UE 120 may be configured with a rule for arranging the sub-groups into a hierarchical structure (e.g., such as arranging a hierarchy in an order of index values of cells). Additionally, or alternatively, the hierarchical structure may be based at least in part on a semi-static configuration. For example, the UE 120 may receive semi-static signaling from the network node 110 with an indicator of the hierarchical structure (or an indicator of a rule from which to construct the hierarchical structure).

Each sub-group of BDs in the hierarchical structure may be for the non-legacy DCI formats that schedule data on a particular set of CCs, as shown in FIG. 8D. As shown in FIG. 8D, at a PDCCH monitoring occasion there are m_{B} BDs for non-legacy DCI formats for a component carrier set and {m₁, m₂, m₃, m₄} BDs for legacy DCI formats for the component carriers {CC1, CC2, CC3, CC4}, respectively. In this case m_{B}+m₃≤36 (e.g., the configured maximum quantity of BDs per component carrier) and m_{B} BDs for non-legacy DCI formats are counted on CC3. In this case, there is a set of subgroups of BDs {m_{B23}, m_{B123}, m_{B1234}}, which the UE 120 may identify based at least in part on, for example, a rule, such as based at least in part on a search space set index, a blind decode index, or a CC index, among other examples, or based at least in part on a higher-layer configuration. According to the hierarchy of subgroups, non-legacy DCI formats that schedule data on CC3 can be transmitted on any of the m_{B} BDs, subject to the condition that m_{B}+m₃≤36. Further, non-legacy DCI formats that schedule data on CC2 or CC3 can be transmitted on any of the m_{B23} BDs out of the m_{B} BDs, subject to the condition that m_{B23}+m₂≤36. Further, non-legacy DCI formats that schedule data on CC1, CC2, or CC3 can be transmitted on any of the m_{B123} BDs out of the m_{B23} BDs, subject to the condition that m_{B123}+m₁≤36. Further, non-legacy DCI formats that schedule data on CC1, CC2, CC3, or CC4 can be transmitted on any of the m_{B1234} BDs out of the m_{B123} BDs, subject to the condition that m_{B1234}+m₄≤36. The aforementioned hierarchy is one example, and other arrangements of hierarchies for arranging BDs for different types of DCI formats are contemplated.

As further shown in FIG. 8A, and by reference number 820, the UE 120 may monitor, on the set of component carriers, for DCI having a DCI format. For example, the UE 120 may monitor for DCI having one or more configured DCI formats and may perform one or more BDs in accordance with a split parameter for DCI monitoring or a hierarchy for DCI monitoring. In this case, the UE 120 may perform the one or more BDs on one or more CCs to receive legacy DCI formats and/or non-legacy DCI formats on the one or more CCs.

As indicated above, FIGS. 8A-8D are provided as an example. Other examples may differ from what is described with respect to FIGS. 8A-8D.

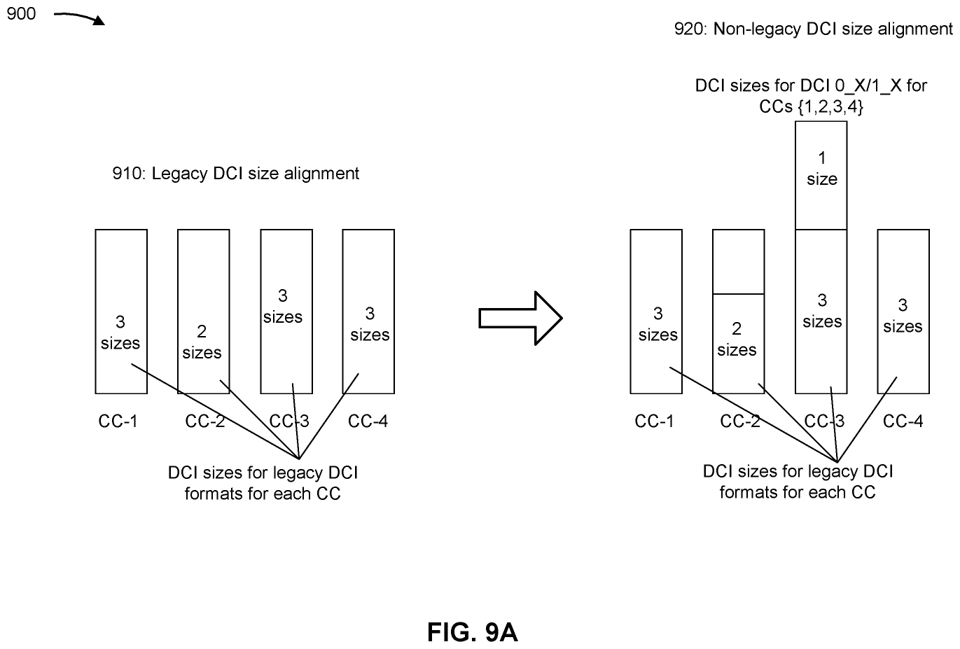

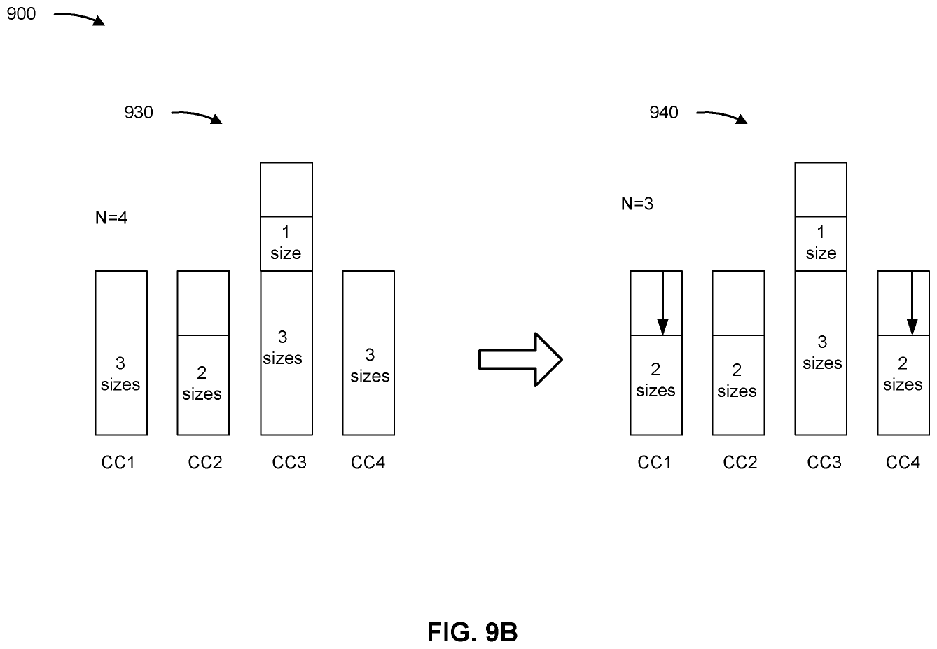

FIGS. 9A-9B are diagrams illustrating an example 900 associated with size alignment in a multi-cell scheduling scenario, in accordance with the present disclosure.

As shown in FIG. 9A, and by reference number 910, a UE (e.g., the UE 120) may perform legacy DCI size alignment. For example, the UE may perform size alignment for a set of legacy DCI formats, as described in more detail with regard to 3GPP TS 38.212, Rel. 16, version 16.10.0, section 7.3.1.0. In this case, the UE may perform size alignment for the set of legacy DCI formats on each cell, such that a quantity of DCI sizes with a C-RNTI is up to 3 DCI sizes for any cell.

As further shown in FIG. 9A, and by reference number 920, the UE may perform non-legacy DCI size alignment. For example, the UE may perform size alignment for a set of non-legacy DCI formats on a cell that is configured to monitor for non-legacy DCI formats. In this case, the UE may recalculate a size of a set of DCI formats with the non-legacy DCI formats and the legacy DCI formats included. As a result, if the quantity of DCI sizes exceeds a maximum value (e.g., 5 DCI sizes in total or 4 DCI sizes with a C-RNTI), the UE may align the non-legacy DCI format sizes to, as shown in FIG. 9A, a single DCI size. Alternatively, the maximum value maybe 4 DCI sizes in total or 3 DCI sizes with a C-RNTI. In some aspects, the UE may treat, as an error case, a scenario where any other cells in a set are configured such that, after legacy DCI size alignment, a total quantity of DCI sizes, including non-legacy DCI sizes, exceeds a configured maximum. In some aspects, the configured maximum may be N+1 for a cell for a total quantity of DCI sizes or N for a cell for a quantity of DCI sizes with a C-RNTI. The quantity N may be a configured value (e.g., 3, 4, or 5) that is based at least in part on a UE capability. If such a scenario occurs, the UE may fail to successfully decode some information as a result of a lack of synchronization on DCI size alignment with a network node (e.g., the network node 110).

Based at least in part on performing non-legacy DCI size alignment, as shown in FIG. 9A and by reference number 920, CC3 has 4 DCI sizes (3 legacy DCI sizes and 1 non-legacy DCI size) to monitor. Alternatively, based at least in part on performing non-legacy DCI size alignment, CC3 has 3 DCI sizes (e.g., 2 legacy DCI sizes and 1 non-legacy DCI size) to monitor. In some aspects, to align the non-legacy DCI formats in size, the UE may add a set of padding bits. For example, when a first payload size (e.g., a first quantity of information bits) in DCI format 0_X (prior to padding) is less than a second payload size of the DCI format 1_X for scheduling the same serving cell or cells, the UE may generate a quantity of zero padding bits for the DCI format 0_X to cause the first payload size to be equal to the second payload size. Similarly, if the first payload size is greater than the second payload size, the UE may generate a quantity of zero padding bits for DCI format 1_X to cause the first payload size to be equal to the second payload size.

In another example, as shown in FIG. 9B, and by reference number 930, after performing legacy DCI size alignment and non-legacy DCI size alignment, the UE 120 may have 3 DCI sizes on CC1, 2 DCI sizes on CC2, 3+1 DCI sizes on CC3 (e.g., 3 legacy DCI format sizes and 1 non-legacy format DCI size), and 3 DCI sizes on CC 4. The quantity of different DCI sizes with a C-RNTI is, as a result, 4 for CC1, 3 for CC2, and 4 for CC4, which is valid for N=4, as described above. However, if the UE reports, as a UE capability, N<4 (e.g., N=3), a network node is triggered to configure DCI formats to monitor on the cells such that a quantity of different DCI sizes with a C-RNTI does not exceed N. Accordingly, the network node may reduce the quantity of legacy DCI sizes to 2 on CC1, CC2, and CC4, as shown in FIG. 9B and by reference number 940.

As indicated above, FIGS. 9A-9B are provided as an example. Other examples may differ from what is described with respect to FIGS. 9A-9B.

FIG. 10 is a diagram illustrating an example process 1000 performed, for example, by a UE, in accordance with the present disclosure. Example process 1000 is an example where the UE (e.g., UE 120) performs operations associated with techniques for monitoring a PDCCH in a multi-cell scheduling scenario.

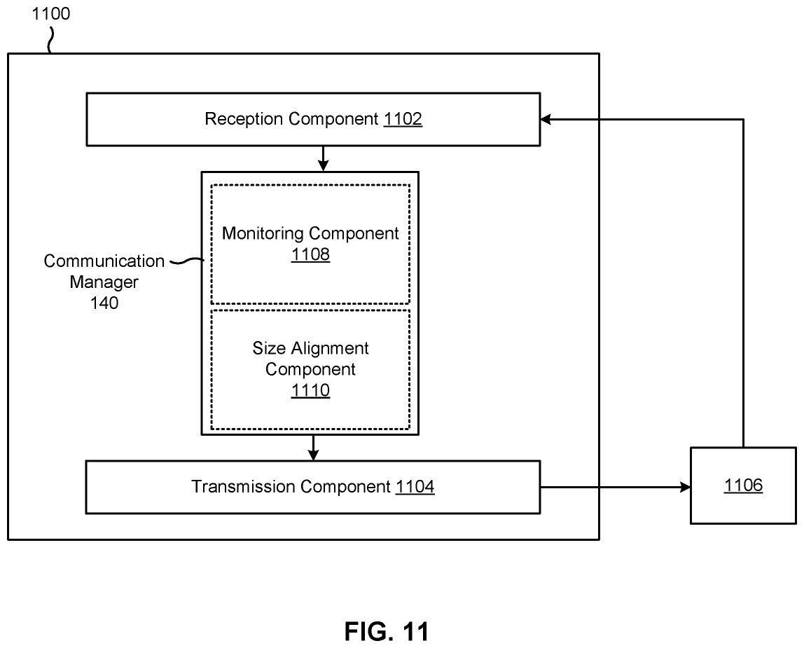

As shown in FIG. 10, in some aspects, process 1000 may include receiving a PDCCH monitoring configuration, the PDCCH monitoring configuration being associated with a set of DCI formats for monitoring on a set of component carriers, the PDCCH monitoring configuration being associated with a split parameter for DCI monitoring or a hierarchy for DCI monitoring (block 1010). For example, the UE (e.g., using communication manager 140 and/or reception component 1102, depicted in FIG. 11) may receive a PDCCH monitoring configuration, as described above. In some aspects, the PDCCH monitoring configuration is associated with a set of DCI formats for monitoring on a set of component carriers. In some aspects, the PDCCH monitoring configuration is associated with a split parameter for DCI monitoring or a hierarchy for DCI monitoring. In some aspects, the operation of block 1010 may be performed by reception component 1102 in FIG. 11. In some aspects, UE may receive a PDCCH monitoring configuration, the PDCCH monitoring configuration being associated with a set of DCI formats for monitoring on a set of component carriers.

As further shown in FIG. 10, in some aspects, process 1000 may include monitoring, on the set of component carriers, for DCI having a format from the set of DCI formats, the monitoring being based at least in part on the split parameter or the hierarchy (block 1020). For example, the UE (e.g., using communication manager 140 and/or monitoring component 1108, depicted in FIG. 11) may monitor, on the set of component carriers, for DCI having a format from the set of DCI formats, the monitoring being based at least in part on the split parameter or the hierarchy, as described above. In some aspects, the operation of block 1020 may be performed by the monitoring component 1108 in FIG. 11. In some aspects, the UE may monitor, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold.

Process 1000 may include additional aspects, such as any single aspect or any combination of aspects described below and/or in connection with one or more other processes described elsewhere herein.

In a first aspect, the split parameter is associated with a quantity of DCI formats, of the set of DCI formats, for monitoring on a common component carrier, of the set of component carriers.

In a second aspect, alone or in combination with the first aspect, process 1000 includes transmitting information identifying a capability for a value of the split parameter.

In a third aspect, alone or in combination with one or more of the first and second aspects, the split parameter or the hierarchy corresponds to a maximum for the quantity of blind decodes.

In a fourth aspect, alone or in combination with one or more of the first through third aspects, the split parameter is applicable to a component carrier, of the set of component carriers, with overlapping control channel elements, or to a component carrier, of the set of component carriers, with non-overlapping control channel elements.

In a fifth aspect, alone or in combination with one or more of the first through fourth aspects, the split parameter is a split ratio or an absolute value.

In a sixth aspect, alone or in combination with one or more of the first through fifth aspects, the hierarchy is based at least in part on a configured static rule or a semi-static configuration.

In a seventh aspect, alone or in combination with one or more of the first through sixth aspects, the hierarchy includes a hierarchy of blind decodes to occur on each component carrier of the set of component carriers.

In an eighth aspect, alone or in combination with one or more of the first through seventh aspects, a subgrouping of blind decodes associated with the hierarchy is based at least in part on at least one of a search space set index, a blind decode index, or a higher-layer configuration.

In a ninth aspect, alone or in combination with one or more of the first through eighth aspects, process 1000 includes aligning a size of DCI having a format 0_X or 1_X with a set of other DCI formats.

In a tenth aspect, alone or in combination with one or more of the first through ninth aspects, the DCI with the format 0_X or 1_X is aligned with a set of padding bits to match a size of another DCI format.

In an eleventh aspect, alone or in combination with one or more of the first through tenth aspects, a quantity of DCI sizes, including the DCI with the format 0_X or 1_X, after DCI size alignment is not greater than a threshold value that is based at least in part on a UE capability.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a monitoring component 1108 or a size alignment component 1110, among other examples.

In some aspects, the apparatus 1100 may be configured to perform one or more operations described herein in connection with FIGS. 8A-9B. Additionally, or alternatively, the apparatus 1100 may be configured to perform one or more processes described herein, such as process 1000 of FIG. 10. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive a PDCCH monitoring configuration, the PDCCH monitoring configuration being associated with a set of DCI formats for monitoring on a set of component carriers, the PDCCH monitoring configuration being associated with a split parameter for DCI monitoring or a hierarchy for DCI monitoring. The monitoring component 1108 may monitor, on the set of component carriers, for DCI having a format from the set of DCI formats, the monitoring being based at least in part on the split parameter or the hierarchy. The transmission component 1104 may transmit information identifying a capability for a value of the split parameter. The size alignment component 1110 may align a size of DCI having a format 0_X or 1_X with a set of other DC formats.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving a physical downlink control channel (PDCCH) monitoring configuration, the PDCCH monitoring configuration being associated with a set of downlink control information (DCI) formats for monitoring on a set of component carriers, the PDCCH monitoring configuration being associated with a split parameter for DCI monitoring or a hierarchy for DCI monitoring; and monitoring, on the set of component carriers, for DCI having a format from the set of DCI formats, the monitoring being based at least in part on the split parameter or the hierarchy.
Aspect 2: The method of Aspect 1, wherein the split parameter is associated with a quantity of DCI formats, of the set of DCI formats, for monitoring on a common component carrier, of the set of component carriers.
Aspect 3: The method of any of Aspects 1-2, further comprising: transmitting information identifying a capability for a value of the split parameter.
Aspect 4: The method of any of Aspects 1-3, wherein the split parameter or the hierarchy corresponds to a maximum for the quantity of blind decodes.
Aspect 5: The method of any of Aspects 1-4, wherein the split parameter is applicable to a component carrier, of the set of component carriers, with overlapping control channel elements, or to a component carrier, of the set of component carriers, with non-overlapping control channel elements.
Aspect 6: The method of any of Aspects 1-5, wherein the split parameter is a split ratio or an absolute value.
Aspect 7: The method of any of Aspects 1-6, wherein the hierarchy is based at least in part on a configured static rule or a semi-static configuration.
Aspect 8: The method of any of Aspects 1-7, wherein the hierarchy includes a hierarchy of blind decodes to occur on each component carrier of the set of component carriers.
Aspect 9: The method of any of Aspects 1-8, wherein a subgrouping of blind decodes associated with the hierarchy is based at least in part on at least one of a search space set index, a blind decode index, or a higher-layer configuration.
Aspect 10: The method of any of Aspects 1-9, further comprising: aligning a size of DC having a format 0_X or 1_X with a set of other DC formats.
Aspect 11: The method of Aspect 10, wherein the DCI with the format 0_X or 1_X is aligned with a set of padding bits to match a size of another DCI format.
Aspect 12: The method of Aspect 10, wherein a quantity of DCI sizes, including the DCI with the format 0_X or 1_X, after DCI size alignment is not greater than a threshold value that is based at least in part on a UE capability.
Aspect 13: A method of wireless communication performed by a user equipment (UE), comprising: receiving a PDCCH monitoring configuration, the PDCCH monitoring configuration being associated with a set of DCI formats for monitoring on a set of component carriers; and monitoring, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold.
Aspect 14: The method of aspect 13, wherein the first DCI format is DCI format 0_3 and the second DCI format is DCI format 1_3.
Aspect 15: The method of any of aspects 13-14, further comprising: aligning sizes of the first DCI format and the second DCI format to align the first payload with the second payload.
Aspect 16: An apparatus for wireless communication at a device, comprising a processor; memory coupled with the processor; and instructions stored in the memory and executable by the processor to cause the apparatus to perform the method of one or more of Aspects 1-15.
Aspect 17: A device for wireless communication, comprising a memory and one or more processors coupled to the memory, the one or more processors configured to perform the method of one or more of Aspects 1-15.
Aspect 18: An apparatus for wireless communication, comprising at least one means for performing the method of one or more of Aspects 1-15.
Aspect 19: A non-transitory computer-readable medium storing code for wireless communication, the code comprising instructions executable by a processor to perform the method of one or more of Aspects 1-15.
Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving a physical downlink control channel (PDCCH) monitoring configuration, the PDCCH monitoring configuration being associated with a set of downlink control information (DCI) formats for monitoring on a set of component carriers, the PDCCH monitoring configuration being associated with a split parameter for DCI monitoring or a hierarchy for DCI monitoring; and
monitoring, on the set of component carriers, for DCI having a format from the set of DCI formats, the monitoring being based at least in part on the split parameter or the hierarchy.

2. The method of claim 1, wherein the split parameter is associated with a quantity of DCI formats, of the set of DCI formats, for monitoring on a common component carrier, of the set of component carriers.

3. The method of claim 1, further comprising:
transmitting information identifying a capability for a value of the split parameter.

4. The method of claim 1, wherein the split parameter or the hierarchy corresponds to a maximum for a quantity of blind decodes.

5. The method of claim 1, wherein the split parameter is applicable to a component carrier, of the set of component carriers, with overlapping control channel elements, or to a component carrier, of the set of component carriers, with non-overlapping control channel elements.

6. The method of claim 1, wherein the split parameter is a split ratio or an absolute value.

7. The method of claim 1, wherein the hierarchy is based at least in part on a configured static rule or a semi-static configuration.

8. The method of claim 1, wherein the hierarchy includes a hierarchy of blind decodes to occur on each component carrier of the set of component carriers.

9. The method of claim 1, wherein a subgrouping of blind decodes associated with the hierarchy is based at least in part on at least one of a search space set index, a blind decode index, or a higher-layer configuration.

10. The method of claim 1, further comprising:
aligning a size of DCI having a format 0_X or 1_X with a set of other DCI formats.

11. The method of claim 10, wherein the DCI with the format 0_X or 1_X is aligned with a set of padding bits to match a size of another DCI format.

12. The method of claim 10, wherein a quantity of DCI sizes, including the DCI with the format 0_X or 1_X, after DCI size alignment is not greater than a threshold value.

13. A user equipment (UE) for wireless communication, comprising:
one or more memories; and
one or more processors, coupled to the memories, configured to:
receive a physical downlink control channel (PDCCH) monitoring configuration, the PDCCH monitoring configuration being associated with a set of downlink control information (DCI) formats for monitoring on a set of component carriers, the PDCCH monitoring configuration being associated with a split parameter for DCI monitoring or a hierarchy for DCI monitoring; and
monitor, on the set of component carriers, for DCI having a format from the set of DCI formats, the monitoring being based at least in part on the split parameter or the hierarchy.

14. The UE of claim 13, wherein the split parameter is associated with a quantity of DCI formats, of the set of DCI formats, for monitoring on a common component carrier, of the set of component carriers.

15. The UE of claim 13, wherein the one or more processors are further configured to:
transmit information identifying a capability for a value of the split parameter.

16. The UE of claim 13, wherein the split parameter or the hierarchy corresponds to a maximum for a quantity of blind decodes.

17. The UE of claim 13, wherein the split parameter is applicable to a component carrier, of the set of component carriers, with overlapping control channel elements, or to a component carrier, of the set of component carriers, with non-overlapping control channel elements.

18. The UE of claim 13, wherein the split parameter is a split ratio or an absolute value.

19. The UE of claim 13, wherein the hierarchy is based at least in part on a configured static rule or a semi-static configuration.

20. The UE of claim 13, wherein the hierarchy includes a hierarchy of blind decodes to occur on each component carrier of the set of component carriers.

21. The UE of claim 13, wherein a subgrouping of blind decodes associated with the hierarchy is based at least in part on at least one of a search space set index, a blind decode index, or a higher-layer configuration.

22. The UE of claim 13, wherein the one or more processors are further configured to:
align a size of DCI having a format 0_X or 1_X with a set of other DCI formats.

23. The UE of claim 22, wherein the DCI with the format 0_X or 1_X is aligned with a set of padding bits to match a size of another DCI format.

24. The UE of claim 22, wherein a quantity of DCI sizes, including the DCI with the format 0_X or 1_X, after DCI size alignment is not greater than a threshold value.

25. A method of wireless communication performed by a user equipment (UE), comprising:
receiving a physical downlink control channel (PDCCH) monitoring configuration, the PDCCH monitoring configuration being associated with a set of downlink control information (DCI) formats for monitoring on a set of component carriers; and
monitoring, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold.

26. The method of claim 25, wherein first DCI format is DCI format 1_3 and the second DCI format is DCI format 0_3.

27. The method of claim 25, further comprising:
aligning sizes of the first DCI format and the second DCI format to align the first payload with the second payload.

28. A user equipment (UE) for wireless communication, comprising:
one or more memories; and
one or more processors, coupled to the memories, configured to:
receive a physical downlink control channel (PDCCH) monitoring configuration, the PDCCH monitoring configuration being associated with a set of downlink control information (DCI) formats for monitoring on a set of component carriers; and
monitor, on the set of component carriers, for a set of DCIs, wherein a first payload of a first DCI format, of the set of DCI formats, for a set of cells for multi-cell downlink scheduling is aligned with a second payload of a second DCI format, of the set of DCI formats, for the set of cells, wherein the first payload is aligned with the second payload in association with a quantity of sizes in the PDCCH monitoring configuration exceeding a threshold.

29. The UE of claim 28, wherein first DCI format is DCI format 1_3 and the second DCI format is DCI format 0_3.

30. The UE of claim 28, wherein the one or more processors are further configured to:
align sizes of the first DCI format and the second DCI format to align the first payload with the second payload.
